(19) United States
(12) Patent Application Publication
(10) Pub. No.: US 2025/0036809 A1
(43) Pub. Date: Jan. 30, 2025

(54) MASKING SENSITIVE INFORMATION

(71) Applicant: Wells Fargo Bank, N.A., San Francisco, CA (US)

(72) Inventor: Carmel Nadav, Eagan, MN (US)

(21) Appl. No.: 17/644,232

(22) Filed: Dec. 14, 2021

(51) Int. Cl. G06F 21/62; G06F 16/33; G06F 40/166; G06F 40/205; G06F 40/295

(52) U.S. Cl. CPC G06F 21/6254

(57) ABSTRACT

Determining and masking sensitive information. Sensitive information, such as personal identifying information, can be present in digitally stored records. For instance, a customer of a business enterprise may submit a textual complaint containing sensitive information that is received and stored by the enterprise. Embodiments of the present disclosure are directed to systems and methods that determine the sensitive information and mask it to reduce vulnerability of the customer and/or to improve the usability of the stored records.

### BACKGROUND

Business enterprises receive and store large amounts of information about individuals, such as customers, clients and employees. Some of the information, such as certain types of identifying information, can be sensitive, creating vulnerabilities in the event the information is ever accessed without authorization. The sensitive information can also limit the usefulness of nonsensitive information received together with the sensitive information.

### SUMMARY

In general terms, the present disclosure is directed to determining and masking sensitive information. The sensitive information can be determined from unstructured text that is then masked to hide the sensitive information within the unstructured text.

In one aspect, a system includes: one or more processors; and non-transitory computer-readable storage media encoding instructions which, when executed by the one or more processors, causes the system to: parse a text string into a parsed text of words; determine that a word of the parsed text is a sensitive word, including to determine that the word of the parsed text corresponds to a word in a structured field of a table stored on a database; mask the sensitive word; and reconstruct the text string with the parsed text while masking the sensitive word.

In another aspect, a computer-implemented method includes: determining that a text string is an unstructured text string, including determining that individual words of the text string do not correspond to structured data fields; parsing the unstructured text string into a parsed text of words; determining that a word of the parsed text is a sensitive word, including determining that the word of the parsed text is identical to a word in a structured field of a table stored on a database; and reconstructing the text string with the parsed text, including masking the sensitive word.

In another aspect, a system includes: one or more processors; and non-transitory computer-readable storage media encoding instructions which, when executed by the one or more processors, causes the system to: determine that a text string is an unstructured text string, including to determine that individual words of the text string do not correspond to structured data fields; parse the unstructured text string into parsed text; determine that a word of the parsed text is a sensitive word, including to determine that the word of the parsed text is identical to a word in a structured field of a table stored on a database; determine a type of the sensitive word; select a predefined mask from a plurality of predefined masks based on the type of the sensitive word; perform natural language processing (NLP) of the unstructured text string; detect, based on the NLP, a number in the unstructured text string, determine, based on the NLP, a type of the number; select a number mask from a plurality of predefined number masks based on the type of the number; and reconstruct the text string with the parsed text, including to mask the sensitive word with the predefined mask and to mask the number with the predefined number mask.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows components of an example system for determining and masking sensitive information.

FIG. 2 is an example method that can be performed by the system of FIG. 1.

FIG. 3 is a further example method that can be performed by the system of FIG. 1.

FIG. 4 is a schematic representation of an output of the method of FIG. 2.

FIG. 5 schematically shows example computing components of a computing device of the system of FIG. 1.

### DETAILED DESCRIPTION

The present disclosure is directed to determining and masking sensitive information. Customers, clients, prospective customers and clients, employees and prospective employees, vendors and prospective vendors, and others, submit textual information to business enterprises for many purposes. In the case of a financial institution, for instance, customers and prospective customers submit applications to open and close financial accounts, to transfer funds, to apply for loans, to submit comments and complaints about products and services, and so forth. Prospective employees can submit information relevant to their potential employment, such as personal information, demographic information, current salary, and desired salary. Existing employees can submit, e.g., positive or negative feedback about other employees, business practices and morale.

The information received by the financial institution or other business enterprise from these various sources is typically stored by the enterprise. The stored information can be used for various purposes. For example, in the case of a financial institution, the stored information can be used to open an account, issue a loan, modify or implement hiring policies, modify or implement advertising campaigns, learn about customers' and employees' likes and dislikes about the financial institution and adjust policies and practices accordingly, ensure compliance with enterprise policies and government regulations, and so forth.

The information submitted can be in the form of structured fields. For example, the information submitted with a loan application can include a name field, a birth date field, an income field, an employer field, and a bank account number field. These types of textual information are highly structured, in that the type of information corresponding to each string of text is known or can be determined based on the type of text field in which the information is entered. Thus, for example, the text submitted in a name field can be determined to be a name by virtue of the type of field.

Information in the form of text submitted to and/or stored by a business enterprise can include sensitive information. Sensitive information, as used herein, refers to any information that, for at least one use application, should be hidden. Examples of sensitive information include personal identifying information (PII), such as a person's name, bank account number, telephone number, social security number, address, and date of birth. Other non-limiting examples of sensitive information can include names of businesses and demographic information.

Example use applications include use applications internal to the business enterprise and external to the business enterprise. For example, within a business enterprise, a first department or division may need to use information submitted to a second department or division. The first department or division may be tasked with some project, such as improving customer relationships, or reducing inherent bias within the enterprise, in marketing materials, or more generally in interactions between the enterprise and its customers. However, in order to perform the project in an unbiased manner, sensitive information, such as PII, must be masked from the information that is supplied to the second department or division.

In an example use application external to the business enterprise, a business enterprise can be concerned with protecting against external breaches of the enterprise's databases. To limit the damage that can arise from such data breaches, as well as to conform with government and other cybersecurity regulations and requirements, sensitive information stored together with non-sensitive information in the enterprise's databases may need to be masked.

As needed, sensitive information in highly structured text can be masked based on the text field. For instance, if name and demography anonymity are required by the institution's policies or a governmental regulation when evaluating a loan application, then the information submitted in the name and demographic fields of the loan application can be automatically omitted when the completed loan application is submitted to a loan officer of the financial institution for review.

Strings of text that are less structured can be more difficult to automatically scrub of sensitive information. For example, an employee of a financial institution may submit a complaint or a comment to their employer about another employee, or a customer of the financial institution may submit a complaint or a comment to the financial institution about a negative or positive experience they have had with a product or service of the financial institution. In some examples, the text of the complaint or comment can be structured to some degree, in that the text is entered into a complaint field or comment field, or email body, of a user interface generated by the financial institution. However, individual words or strings of words within the block of text are unstructured. That is, the complaint or comment text can be broadly structured as a complaint comment, but specific information that may be included within the block of complaint or comment text, such as names of people, names of businesses, account numbers, social security numbers, and so forth, are unstructured.

As used herein, a block of text stored in a computer readable medium that includes sensitive information or could include sensitive information and is submitted in a text field that is not structured to isolate such sensitive information will be referred to as unstructured text.

Algorithms that perform natural language processing (NLP) can be applied to unstructured text to determine if the text includes sensitive information. However, NLP-based algorithms can be costly, requiring significant expenditure of computing resources and taking significant time to obtain the desired output, particularly when an NLP algorithm is tasked with understanding words rather than numbers and determining whether words in unstructured text are sensitive information.

Advantageously, computer-implemented systems and methods of the present disclosure are configured to automatically determine sensitive information in unstructured text without the use of natural language processing algorithms. When sensitive information is detected, it is automatically masked, again without the use of natural language processing algorithms, and the unstructured text is reconstructed, with the sensitive information masked.

The terms mask or masked, as used herein, refers to text (such as a word or a number) that is concealed in some way. In the case of a word that is sensitive information, the word is masked such that the sensitive aspect of the word is eliminated. For example, to mask a word from a string of text, the word can be simply deleted from the string. For instance, the string of text “the cat belongs to John Smith of the United Kingdom” is replaced with “the cat belongs to of the United Kingdom”. In another example of masking, a masked word such as “John” or “Smith” is replaced with one or more characters that hide what the word was, such as “XXXX”. For instance, the string of text “the cat belongs to John Smith of the United Kingdom” is replaced with “the cat belongs to XXXX XXXX of the United Kingdom”. Similarly, a masked number such as a social security number can be replaced with one or more numeric characters, such as “000000”.

Further advantageously, in certain embodiments, computer-implemented systems and methods of the present disclosure are configured to mask sensitive information with masks that are selected based on a type of information that is being masked, such that a user can determine what type of information in the unstructured text has been masked without being able to access the sensitive information itself. For example, the masked word is replaced with a pseudonym that indicates a type of the word that is being masked without revealing the sensitive information of the word itself. For instance the string of text “the cat belongs to John Smith of the United Kingdom” is replaced with “the cat belongs to NAME NAME of the United Kingdom”, in which each of the names “John” and “Smith” is replaced with the pseudonym “NAME”.

By automating masking of sensitive information according to embodiments of the present disclosure, several practical applications can be realized.

For example, computing resources are used more efficiently because the use of computationally intensive NLP algorithms for detecting and masking sensitive information is reduced or eliminated. Similarly, masking of large amounts of sensitive information stored in one or more databases can be performed much more quickly. That is, according to embodiments of the present disclosure, a masking of sensitive information is performed more computationally efficiently by performing computational operations without using NLP, or by using NLP to a lesser degree.

According to another example practical application realized by embodiments of the present disclosure, sensitive information, such as PII, presented in unstructured text is protected from cybersecurity breaches.

According to another example practical application realized by embodiments of the present disclosure, a business enterprise can more efficiently share and use unstructured text within the enterprise without detrimental awareness of sensitive information contained in the unstructured text, where awareness of such sensitive information could jeopardize or undermine the project for which the unstructured text is being used.

According to another example practical application realized by embodiments of the present disclosure, the types of information that have been masked in a stored, unstructured text string can be readily appreciated. Knowing the types of information that have been masked can, e.g., inform a user of the unstructured text string whether certain information may have been masked incorrectly, or ought to be unmasked for a limited purpose of the user. For instance, for a given project, personal names may be considered sensitive information that must be masked from the user, while business names may need to be known. According to embodiments of the present disclosure, personal names can be masked with a different indicator or pseudonym than a business name, allowing the user to determine, for example, if certain masked information (information masked to indicate that it includes a business name) should be unmasked. That is, certain embodiments can differentiate between a first type of sensitive information masked in a first way (e.g., using a first mask), and a second type of information masked in a second way. In these embodiments certain types of sensitive information may be selectively unmasked. For instance, information of a first type may be selected and unmasked, while information of the second type remains masked. While only two types of sensitive information (and corresponding unique masks) are described, in various other examples, three, four, or any number of types of sensitive information (and corresponding unique masks) may be used.

According to still further practical applications realized by embodiments of the present disclosure, sensitive information in unstructured text strings can be determined by referencing a repository of sensitive terms that is updated over time. For example, as new businesses are opened, new business names can be added to a business name repository. The business name repository can be publicly available for use by a business enterprise, such as a financial institution seeking to scrub stored unstructured text of business names. Similarly, the variety of personal names is ever changing and increasing. A word that is used as a personal name today may not have been used as a personal name 20 years ago or 100 years ago. By accessing a repository of personal names that is updated over time to include new names, a business enterprise, such as financial institution, can mask from unstructured text strings even the personal names that have been adopted recently.

Further advantages and practical application will be borne out by the present disclosure.

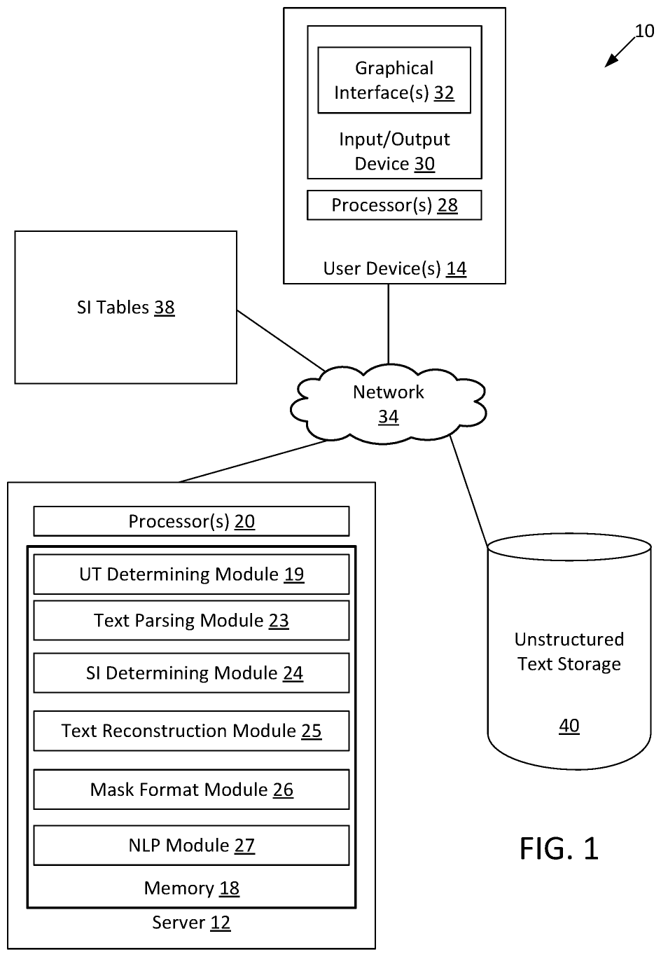

FIG. 1 schematically shows components of an example system 10 according to the present disclosure. The system 10 includes a server 12 and one or more user device(s) 14.

Each user device 14 is a computing device, such as a laptop computer, a desktop computer, a tablet computer, a smartphone, etc.

In some examples, one of the user devices 14 can be associated with an individual who submits an unstructured text string containing sensitive information to a business enterprise, and another user device 14 can be associated with a stakeholder of the business enterprise who is tasked with using the submitted information in some way.

In other examples, one of the user devices 14 can be associated with an individual who submits an unstructured text string containing sensitive information to a business enterprise, and another user device 14 can be associated with an individual or entity that accesses the server 12 without authorization, and thereby accesses the unstructured text string.

The server 12 is a computing device configured to detect sensitive information in unstructured text strings and to mask such sensitive information in accordance with the present disclosure using an unstructured text (UT) determining module 19, a text parsing module 23, a sensitive information (SI) determining module 24, and a text reconstruction module 25. In some examples, the server 12 also includes a mask format module 26. In some examples, the server 12 also includes a natural language processing (NLP) module 27. Each of the modules 19, 23, 24, 25, 26 and 27 may be stored on a memory 18 of the server 12.

The server 12 can be associated with a given financial services institution or other business enterprise. The server 12 can be configured to be accessed only by the institution to which it is associated, and in certain situations only by certain authorized employees of the institution. Alternatively, the server 12 can correspond to shared computing resources, such as a cloud, to which a given business enterprise can gain access for their private computing needs.

The server 12 includes one or more processor(s) 20 configured to process data and execute computer readable instructions stored on the memory 18, for performing functions of the server 12 described herein. For example, the processor(s) 20 can be configured to carry out the functionality of the modules, 23, 24, 25, 26 and 27.

Each user device 14 includes one or more processor(s) 28 and an input/output (I/O) device 30. The I/O device 30 is configured to generate graphical interface(s) 32, and/or audio interfaces. For example, the I/O device 30 can include a touch screen, a microphone and/or a speaker. The processor(s) 28 can execute computer readable instructions for performing functions of the user device 14, such as displaying graphical interfaces and otherwise providing output for a user to see or hear, and receive input from the user.

The system 10 includes an unstructured text storage 40. The storage 40 can be a database associated with the business enterprise, or a shared storage to which the business enterprise can gain access. In some examples, the unstructured text storage 40 is part of the memory 18. The unstructured text storage 40 is a database that stores unstructured text strings that may contain sensitive information. For example, the unstructured text storage 40 can store unstructured comments, complaints and emails from customers, prospective customers, employees and the like.

The system 10 also includes sensitive information (SI) tables 38. The tables 38 can be publicly accessible or at least accessible to the business enterprise. The tables 38 can be updated in real time or on a periodic basis. The tables 38 include repositories of words that can be referenced by the server 12 to determine whether an unstructured text string includes sensitive information.

For example, one or more of the tables 38 can be provided and updated by a credit bureau that lists all individual names known to the credit bureau. The names can be divided into a surnames table and first names (including middle names) table. Alternatively, a single table can include all first names, middle names and surnames. As another example, one or more of the tables 38 can be provided and updated by a business bureau that lists all business names known to the business bureau.

Each table 38 can include a single column or a single row of cells, where each cell in the column or the row includes a word that could be sensitive information.

Which table or tables 38 that is/are selected for a given masking operation can depend on the intended users of the unstructured text and the types of information those users are permitted to have knowledge of. While illustrated separate from the server 12 and unstructured text storage 40, it is appreciated that in other examples the SI Tables 38 may be stored in the same storage location as the unstructured text storage 40. In some instances, this may be the memory 18 of the server. In still other examples, the SI tables may be stored separate from the unstructured text storage 40, and as part of the memory 18.

The server 12, the user device(s) 14, the SI tables 38, and the unstructured text storage 40 (if it is not incorporated into the memory 18) are interconnected via a network 34. The network 34 can be any suitable data network, such as the internet, a wide area network, a local area network, a wired network, a wireless network, a cellular network, a satellite network, a near field communication network, or any operatively connected combination of these. Inputs to the user device(s) 14 can be received by the server 12 via the network 34 and vice versa.

The unstructured text (UT) determining module 19 is configured to determine whether a string of text is unstructured. For example, the UT determining module 19 can determine whether a string of text is unstructured based on the type of data field that the string of text has been entered into. For instance, The UT determining module 19 can determine that a string of text is structured because its data field type is for a name or a phone number, whereas the UT determining module 19 can determine that another string of text is unstructured because its data field type is for a comment or a complaint, or for a body of any email.

In some examples, the UT determining module 19 is configured to mask certain structured text based on the type of data field in which the structured text was entered. For example, the UT determining module 19 can be configured to automatically mask all personal names entered into structured name fields of a loan application.

The text parsing module 23 is configured to parse a string of unstructured text. In some examples, the text parsing module 23 is configured to tabularize a string of unstructured text, with each word or similar textual element (e.g., a telephone number) occupying its own dedicated cell in a row or a column of a table. In some examples, the text parsing module 23 is also configured to remove certain textual features from the unstructured text string, such as capital letters, punctuation, stylization, and so forth. Thus, the text parsing module 23 can scrub an unstructured text string such that the only elements that the text parsing module 23 causes to populate the cells of the parsed text table are the words (or similar textual elements, such as alphanumeric strings).

By parsing the unstructured text string with the text parsing module 23, the words or similar textual elements of the unstructured text string themselves can be compared to the words and similar textual elements of the SI tables 38 without comparing other textual features that may result in false negative matches between the unstructured text string and the SI tables 38.

The SI determining module 24 is configured to determine whether an unstructured text string includes sensitive information. Stated another way, the SI determining module 24 is configured to detect sensitive information in unstructured text strings.

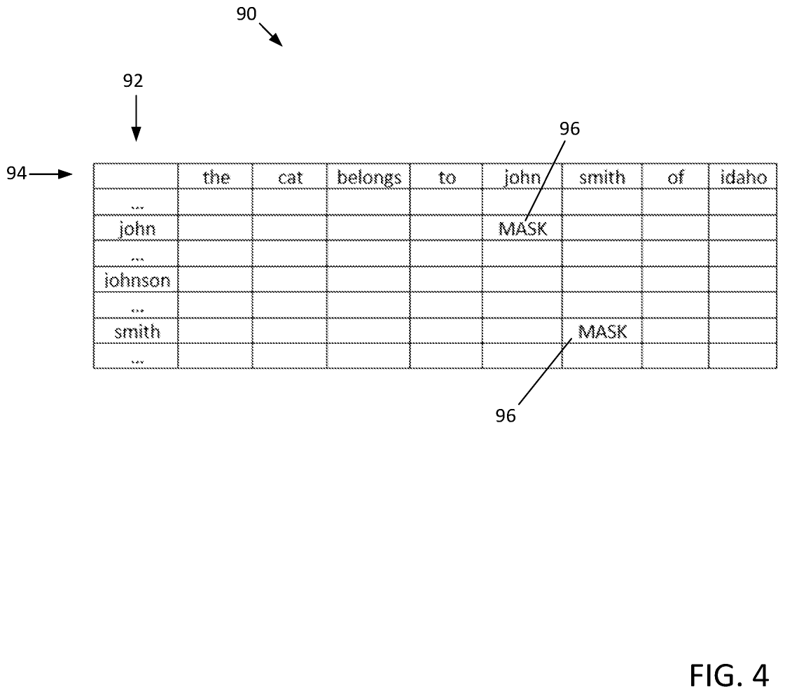

In some examples, the SI determining module 24 is configured to detect sensitive information by joining a parsed text table representing an unstructured text string, and generated by the text parsing module 23, with one or more of the SI tables 38. An example of the output of such a table joining operation is represented in FIG. 4, which includes a joined table 90 that has been joined by the SI determining module 24.

Referring to FIGS. 1 and 4, the text parsing module 23 has parsed the unstructured text string, “The cat belongs to John Smith of Idaho.” into a parsed table containing the words shown in the row 94 of the table 90. The SI determining module 24 has joined the parsed text table together with a SI name table 38, which is provided as a column 92 of the table 90.

The SI determining module 24 is configured to compare each word in the row 94 with each word in the column 92, and to detect any matches therebetween. In certain examples, the SI determining module 24 may execute the comparison by comparing each character (e.g., letter, number, alphanumeric character, or the like) of the compared words to determine a match. In these examples, a match may be detected when each character of a word matches a character of the compared word in the same ordinality. In certain examples, the SI determining module 24 may execute the comparison by comparing each word as a whole. In the illustrated example, matches were identified for the word “john” and for the word “smith”. That is, “john” as it appears in the row 94 was matched to “john” as it appears in column 92. Similarly, “smith” as it appears in row 94 was matched to “smith” as it appears in column 92. For each match, the SI determining module 24 is configured to label the match as sensitive information that must be masked, as represented by “MASK” in the cells 96 of the table 90.

The text reconstruction module 25 is configured to reconstruct the unstructured text string with the sensitive information masked. Thus, in some examples, the text reconstruction module 25 can take the joined table (such as the table 90) as input and provide as output a reconstructed text string with the detected sensitive information masked in a way such that the sensitive information cannot be understood by an individual. For example, for the unstructured text string represented in the row 94 of the table 90, the text reconstruction module 25 can mask the sensitive information (i.e., the matched words) by removing the matched words to provide as output “the cat belongs to of idaho”. As another example, the text reconstruction module 25 can mask the sensitive information by replacing the matched words with an indicator or pseudonym. For instance, the text reconstruction module 25 may provide as output “the cat belongs to NAME NAME of idaho”.

Text strings reconstructed by the text reconstruction module 25 can be stored. For example, reconstructed text strings can be stored in the memory 18 and/or the storage 40. In some examples, the reconstructed text string replaces the original text string in storage, such that the original text string is no longer accessible. In some examples, different permissions are assigned to original text strings and reconstructed text strings. For example, one set of stakeholders of a business enterprise may be permitted access to stored reconstructed text strings (with sensitive information masked) whereas only a subset of those stakeholders may be permitted access to the original unstructured text strings.

The mask format module 26, like the SI determining module 24, is also configured to detect sensitive information in unstructured text strings and mask such information. In some examples, the mask format module 26 is configured to perform text parsing in line with the functionality of the text parsing module 23 as described above. In some examples, the mask format module 26 is configured to detect sensitive information using the SI tables 38 in line with the corresponding functionality of the SI determining module 24 described above. In some examples, the mask format module 26 is configured to perform text reconstruction in line with the functionality of the text reconstruction module 25 described above.

The mask format module 26 is configured to receive as input an unstructured text string that may contain sensitive information, apply a format operation to the input, and generate an output that includes the text string reconstructed with detected sensitive information masked. The mask format module 26 can map the sensitive information detected in the unstructured text string to one or more masks.

For example, the unstructured text string can be inserted as an argument in a format function that returns a value of that function. The value that the function returns is the reconstructed text string, in which the sensitive information is masked.

In some examples, the mask format module 26 applies a FORMAT function to the unstructured text string, the FORMAT function being a programming function provided by SAS® (Cary, North Carlina) and configured by the business enterprise. For example, the mask format module 26 can perform the following expression:
FORMAT(unstructured text string)=(reconstructed text string with SI masked)

The mask format module 26 can be configured to mask sensitive information based on a type of the sensitive information by mapping each detected sensitive word to a corresponding mask form based on the type of sensitive word. In some examples, the format module 26 is configured to select a mask from a set of predefined masks based on the type of sensitive information being masked. For example, personal names can be masked with a different form of mask than business names. For instance, for the unstructured text string, “Roberta went to a Wells Fargo branch in Idaho.” the format module 26 can be configured to map “Roberta” to “XXXX” and “Wells Fargo” to “YYYY” or “YYYY YYYY” (depending on how the business name Wells Fargo is presented in a table 38). The mask format module 26 can then reconstruct the text string with the mapped-to masked words, to read “XXXX went to a YYYY branch in idaho”.

By differentiating mask forms based on the type of sensitive word, the consumer of the text string containing masked sensitive information advantageously can be made aware of the type of sensitive information that has been masked without revealing the sensitive information itself.

The natural language processing (NLP) module 27 is configured to perform natural language processing of the unstructured text string. Natural language processing can include, for example, machine learning algorithms that apply a multi-dimensional vector analysis to align, most closely align, or align within acceptable predefined tolerances, attributes of parsed words or other strings of characters (e.g., numbers) from the unstructured text with attributes of words and other strings of text that have known meanings. The NLP module 27 can use the context of a word or other string of words to determine its meaning. For example, the NLP module 27 can determine the meaning of a word based in part on the meaning of one or more words near it.

According to certain embodiments of the present disclosure, the NLP module 27 can be used in conjunction with the SI determining module 24 to perform masking of sensitive information in a given unstructured text string. In some examples, the processor(s) 20 are configured to perform, with respect to a given unstructured text string, natural language processing with the NLP module 27 and SI determination with the SI determining module 24 in parallel, e.g., simultaneously. Performing NLP and SI determination in parallel can save computational processing time.

For a given unstructured text string, the NLP module 27 can be used to identify certain types of sensitive information, such as phone numbers, social security numbers and birth dates, that are present in the unstructured string. Performing NLP on such types of information can be significantly less computationally intensive than, e.g., performing NLP to identify personal names or names of businesses. For instance, it can be computationally intensive to determine, using NLP, if a parsed term “apple” refers to a fruit or to a business. In contrast, if the NLP module 27 encounters a number that has format attributes (e.g., nine digits) that match the format of a social security number, the NLP module 27 can flag the number as sensitive information and a mask can be applied to the number. In some examples, the NLP module 27 is also configured to apply a mask to the sensitive information that it has detected, which mask is included when the text is reconstructed by the text reconstruction module 25.

Thus, it can be advantageous in certain examples to deploy the SI determining module 24 to detect certain types of sensitive information (e.g., personal names, business names) in an unstructured text string, and to deploy the NLP module 27 to detect other types of sensitive information (e.g., telephone numbers and social security numbers).

In some examples, the NLP module 27 is configured to determine a type of number detected in an unstructured text string, and to select a number mask from a plurality of predefined number masks based on the type of the number. That is, for example, a different mask (“PHONE”) can be applied to a telephone number than a mask (“SSN”) applied to a social security number.

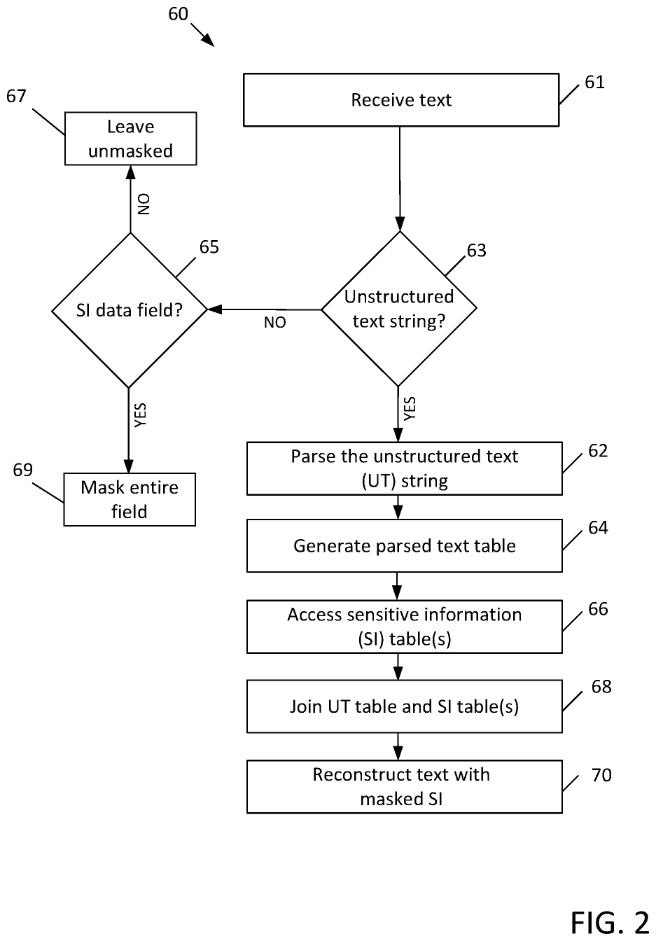

FIG. 2 is an example method 60 that can be performed by the system 10 of FIG. 1.

Referring to FIG. 2, at a step 61 of the method 60 text is received. For example, text is provided to a business enterprise by a customer or employee using a user device 14 (FIG. 1).

At a step 63 of the method 60, the UT determining module 19 (FIG. 1) determines if the received text is structured or unstructured. If the UT determining module 19 determines that the received text is structured, then the method 60 proceeds to the step 65. If the UT determining module 19 determines that the received text is unstructured, then the method 60 proceeds to the step 62.

At the step 65 of the method 60, the UT determining module 19 determines if the structured text has been entered into a data field predefined to be sensitive information, such as a personal name or a social security number, or if the structured text has been entered into a data field predefined to be not sensitive information, such as an email address.

If the UT determining module 19 determines that the structured data field is sensitive information, the method 60 proceeds to the step 69. If the UT determining module 19 determines that the structured data field is not sensitive information, the method 60 proceeds to the step 67.

At the step 67 of the method 60, the data in the structured data field is left unmasked because the data field was determined at the step 65 to be not sensitive information.

At the step 69 of the method 60, the data in the structured data field is masked, e.g., by the UT determining module 19, because the data field was determined at the step 65 to be sensitive information.

As mentioned, if at the step 63 the UT determining module 19 determines that the received text is unstructured, then the method 60 proceeds to the step 62. Optionally, the text is stored in the unstructured text storage 40 (FIG. 1).

At the step 62 of the method 60, the text parsing module 23 (FIG. 1) parses the unstructured text.

At a step 64 of the method 60, the SI determining module 24 (FIG. 1) generates a parsed text table (e.g., the row 94 of FIG. 4) with the parsed text generated at the step 62.

At a step 66 of the method 60, the SI determining module 24 accesses one or more SI table(s) 38 (FIG. 1).

At a step 68 of the method 60, the SI determining module 24 joins the parsed text table generated at the step 64 with an SI table 38 to generate a joined table (e.g., the table 90 of FIG. 4). Words that match each other in the joined table are masked.

At a step 70 of the method 60, the text reconstruction module 25 reconstructs the text including masked sensitive information. In some examples, the reconstructed text replaces the original text stored in the unstructured text storage 40. The reconstructed text, including masked information, can now be presented to, e.g., a stakeholder of the business enterprise via a user device 14 (FIG. 1).

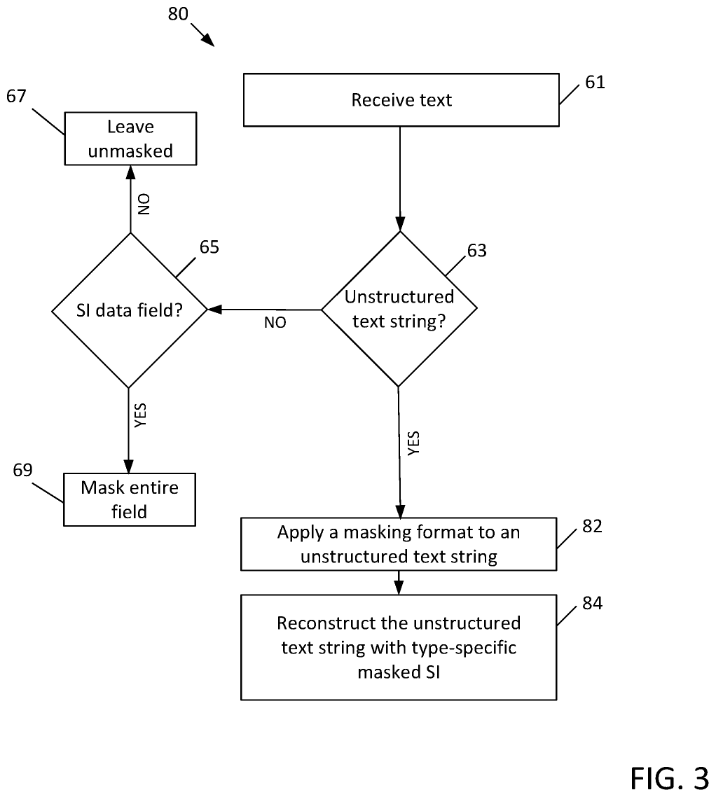

FIG. 3 is a further example method 80 that can be performed by the system 10 of FIG. 1. The method 80 includes the steps 61, 63, 65, 67 and 69, which were described above in connection with the method 60 (FIG. 1).

If at the step 63 the UT determining module 19 determines that the received text is unstructured, then the method 80 proceeds to the step 82. Optionally, the text is stored in the unstructured text storage 40 (FIG. 1).

At the step 82, the mask format module 26 (FIG. 1) applies a predefined format operation to the received text.

At a step 84 of the method 80, the format module 26 generates an output, using the predefined format operation that reconstructs the text including masked sensitive information. In some examples, the format module 26 masks the sensitive information based on a determined type of the sensitive information, and applies a mask form or mask type specific to the type of sensitive information. In some examples, the reconstructed text replaces the original text stored in the unstructured text storage 40. The reconstructed text, including masked information, can now be presented to, e.g., a stakeholder of the business enterprise via a user device 14 (FIG. 1).

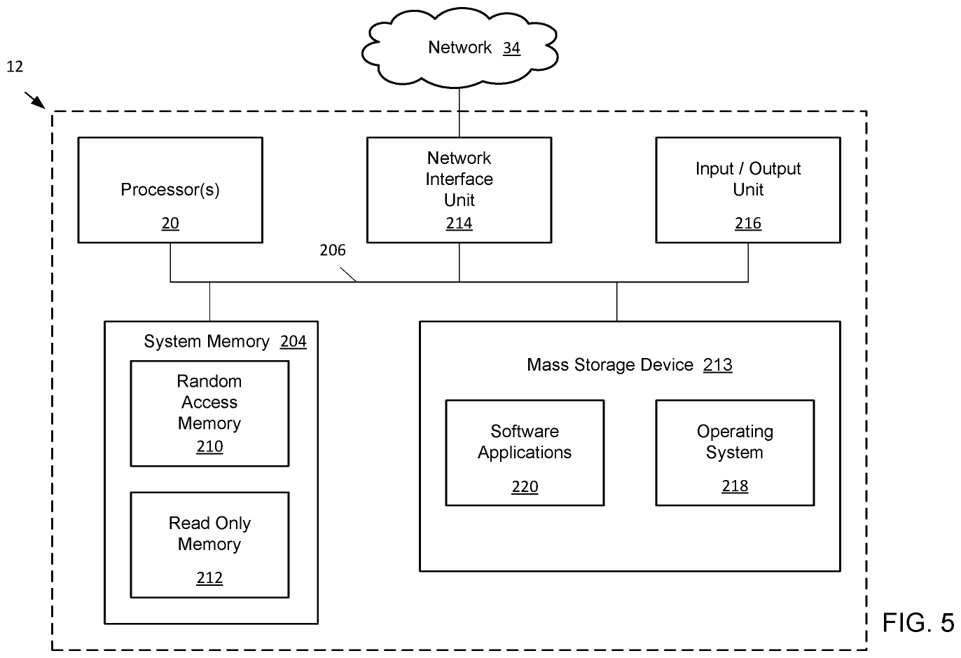

Additional components of the server 12 are illustrated in FIG. 5. In this example, the server 12 provides the computing resources to perform the functionality associated with the system 10 (FIG. 1). The user device(s) 14 and other computing resources associated with the system 10 can be similarly configured.

The server 12 can be an internally controlled and managed device (or multiple devices) of the financial institution or other business enterprise. Alternatively, the server 12 can represent one or more devices operating in a shared computing system external to the institution or enterprise, such as a cloud. Further, the other computing devices disclosed herein can include the same or similar components, including the user device(s) 14.

Via the network 34, the components of the server 12 that are physically remote from one another can interact with one another.

The server 12 includes the processor(s) 20, a system memory 204, and a system bus 206 that couples the system memory 204 to the processor(s) 20.

The system memory 18 includes a random access memory (“RAM”) 210 and a read-only memory (“ROM”) 212. A basic input/output system that contains the basic routines that help to transfer information between elements within the server 12, such as during startup, is stored in the ROM 212.

The server 12 further includes a mass storage device 213. The mass storage device 213 can correspond to the memory 18 of the system 10 (FIG. 1). The mass storage device 213 is able to store software instructions and data, such as the modules 19, 23, 24, 25, 26 and 27 (FIG. 1). The mass storage device 213 can also include unstructured text storage 40 (FIG. 1).

The mass storage device 213 is connected to the processor(s) 20 through a mass storage controller (not shown) connected to the system bus 206. The mass storage device 213 and its associated computer-readable data storage media provide non-volatile, non-transitory storage for the server 12. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 12.

According to various embodiments of the invention, the server 12 may operate in a networked environment using logical connections to remote network devices through the network 34, such as a wireless network, the Internet, or another type of network. The server 12 may connect to the network 34 through a network interface unit 214 connected to the system bus 206. It should be appreciated that the network interface unit 214 may also be utilized to connect to other types of networks and remote computing systems. The server 12 also includes an input/output unit 216 for receiving and processing input from a number of other devices, including a touch user interface display screen, an audio input device, or another type of input device. Similarly, the input/output unit 216 may provide output to a touch user interface display screen or other type of output device, including, for example, the I/O device 30 (FIG. 1).

As mentioned briefly above, the mass storage device 213 and/or the RAM 210 of the server 12 can store software instructions and data. The software instructions include an operating system 218 suitable for controlling the operation of the server 12. The mass storage device 213 and/or the RAM 210 also store software instructions and applications 220, that when executed by the processor(s) 20, cause the server 12 to provide the functionality of the system 10 described above (FIG. 1).

Although various embodiments are described herein, those of ordinary skill in the art will understand that many modifications may be made thereto within the scope of the present disclosure. Accordingly, it is not intended that the scope of the disclosure in any way be limited by the examples provided.

1. A system, comprising:
one or more processors; and
non-transitory computer-readable storage media encoding instructions which, when executed by the one or more processors, causes the system to:
parse a text string into a parsed text of words;
generate a first table with the parsed text of words;
determine that a word of the parsed text is a sensitive word, including to determine that the word of the parsed text corresponds to a word in a structured field of a second table stored on a database, wherein to determine that the word of the parsed text is the sensitive word includes to join the first table and the second table to generate a third table in which the first table is a row and the second table is a column;
mask the sensitive word, including to label a cell of the third table as information to be masked to provide a labeled third table; and
reconstruct the text string with the parsed text while masking the sensitive word, including to receive the labeled third table as input and provide, as output based on the input, a reconstructed text string with the sensitive word masked.

2. The system of claim 1, wherein the non-transitory computer-readable storage media encodes further instructions which, when executed by the one or more processors, causes the system to:
prior to the parse, determine that the text string is an unstructured text string, including to determine that individual words of the text string do not correspond to structured data fields.

3. (canceled)

4. The system of claim 1, wherein the non-transitory computer-readable storage media encodes further instructions which, when executed by the one or more processors, causes the system to:
format the sensitive word as a predefined mask.

5. The system of claim 4, wherein to format the sensitive word includes to:
determine a type of the sensitive word; and
select the predefined mask from a plurality of predefined masks based on the type.

6. The system of claim 5, wherein the type is one of a personal name and a business name.

7. The system of claim 1, wherein the non-transitory computer-readable storage media encodes further instructions which, when executed by the one or more processors, causes the system to:
perform natural language processing of the text string; and
detect, based on the natural language processing, a number in the text string,
wherein to reconstruct the text string with the parsed text includes to mask the number with a number mask.

8. The system of claim 7, wherein to perform the natural language processing includes to:
determine a type of the number; and
select the number mask from a plurality of predefined number masks based on the type of the number.

9. The system of claim 8, wherein the type of the number is one of a telephone number, an account number, a transaction card number, a date, and a social security number.

10. The system of claim 7, wherein to detect includes to:
determine a type of the number; and
determine, based on the type of the number, that the number needs to be masked.

11. A computer-implemented method, comprising:
determining that a text string is an unstructured text string, including determining that individual words of the text string do not correspond to structured data fields;
parsing the unstructured text string into a parsed text of words;
generating a first table with the parsed text of words;
determining that a word of the parsed text is a sensitive word, including determining that the word of the parsed text is identical to a word in a structured field of a second table stored on a database, wherein determining that the word of the parsed text is the sensitive word includes joining the first table and the second table to generate a third table in which the first table is a row and the second table is a column;
labeling a cell of the third table as information to be masked to provide a labeled third table; and
reconstructing the text string with the parsed text, including masking the sensitive word, by receiving the labeled third table as input and providing, as output based on the input, a reconstructed text string with the sensitive word masked.

12. (canceled)

13. The method of claim 11, further comprising:
formatting the sensitive word as a predefined mask.

14. The method of claim 13, wherein formatting includes:
determining a type of the sensitive word; and
selecting the predefined mask from a plurality of predefined masks based on the type.

15. The method of claim 14, wherein the type is one of a personal name and a corporate name.

16. The method of claim 11, further comprising:
performing natural language processing of the unstructured text string; and
detecting, based on the natural language processing, a number in the unstructured text string,
wherein reconstructing includes masking the number with a number mask.

17. The method of claim 16, wherein performing the natural language processing includes:
determining a type of the number; and
selecting the number mask from a plurality of predefined number masks based on the type of the number.

18. The method of claim 17, wherein the type of the number is one of a telephone number, an account number, a transaction card number, a date, and a social security number.

19. The method of claim 16, wherein detecting includes:
determining a type of the number; and
determining, based on the type of the number, that the number needs to be masked.

20. A system, comprising:
one or more processors; and
non-transitory computer-readable storage media encoding instructions which, when executed by the one or more processors, causes the system to:
determine that a text string is an unstructured text string, including to determine that individual words of the text string do not correspond to structured data fields;
parse the unstructured text string into a parsed text of words;
generate a first table with the parsed text of words;
determine that a word of the parsed text is a sensitive word, including to determine that the word of the parsed text is identical to a word in a structured field of a second table stored on a database, wherein to determine that the word of the parsed text is the sensitive word includes to join the first table and the second table to generate a third table in which the first table is a row and the second table is a column;
label a cell of the third table as information to be masked to provide a labeled third table;
determine a type of the sensitive word;
select a predefined mask from a plurality of predefined masks based on the type of the sensitive word;
perform natural language processing of the unstructured text string;
detect, based on the natural language processing, a number in the unstructured text string,
determine, based on the natural language processing, a type of the number;
select a number mask from a plurality of predefined number masks based on the type of the number; and
reconstruct the text string with the parsed text, including to:
mask the sensitive word with the predefined mask by receiving the labeled third table as input and providing, as output based on the input, a reconstructed text string with the sensitive word masked; and
mask the number with the predefined number mask.
